(19) United States
(12) Patent Application Publication
(10) Pub. No.: US 2024/0360717 A1
(43) Pub. Date: Oct. 31, 2024

(54) VEHICULAR CLOSURE PANEL ACTUATOR WITH MAGNETIC CLUTCH

(71) Applicant: Magna Mirrors of America, Inc., Holland, MI (US)

(72) Inventors: Connor G. Cervone, Byron Center, MI (US); Bryce A. Hilborn, Grand Rapids, MI (US)

(21) Appl. No.: 18/644,212

(22) Filed: Apr. 24, 2024

Related U.S. Application Data
(60) Provisional application No. 63/498,054, filed on Apr. 25, 2023.

(51) Int. Cl. E05F 15/63; B60L 53/16; F16D 27/01

(52) U.S. Cl. CPC E05F 15/63; B60L 53/16; E05Y 2201/216; E05Y 2201/46; E05Y 2201/71; E05Y 2900/534; F16D 27/01

(57) ABSTRACT

A vehicular charge port closure system includes a cover panel disposed at a vehicle and an actuator. The actuator includes an electrically operable motor that, when electrically operated to move the cover panel between a closed position and an opened position, drives gears to impart movement of an output element. The output element is connected to the cover panel. A clutch is disposed between one of the gears and the output element. When the motor is operated to drive the gears, the clutch is engaged to move the cover panel, and when the cover panel is manually moved, the clutch is disengaged. The clutch includes a magnetic biasing element.

### CROSS REFERENCE TO RELATED APPLICATION

The present application claims the filing benefits of U.S. provisional application Ser. No. 63/498,054, filed Apr. 25, 2023, which is hereby incorporated herein by reference in its entirety.

### FIELD OF THE INVENTION

The present invention relates to a charge port or fuel port of a vehicle.

### BACKGROUND OF THE INVENTION

It is known to cover or conceal a fuel port of a vehicle or a charging port of an electric vehicle with a flap or door that is pivotable relative to the port between a closed position, where the flap is disposed over the port to cover and conceal the port, and an opened position, where the flap is pivoted away from the port to expose the port for receiving a fuel source or electrical connector of a charging station. Commonly, the flap is located at the side of the vehicle and is manually pivotable between the closed and opened positions.

### SUMMARY OF THE INVENTION

A vehicular closure system for a charge port cover panel includes a cover panel disposed at a vehicle equipped with the vehicular closure system. The cover panel is movable between (i) a closed position, where the cover panel conceals a charge port of the vehicle, and (ii) an opened position, where the cover panel is moved away from the charge port to allow access to a charging connector of the charge port. The cover panel is pivotally mounted to a base portion at the vehicle. When the cover panel moves between the closed position and the opened position, the cover panel pivots about a pivot axis relative to the base portion. An actuator assembly is electrically operable to move the cover panel between the closed position and the opened position. The actuator assembly includes an electrically operable motor that, when electrically operated to move the cover panel between the closed position and the opened position, drives an output element of the actuator assembly. The output element of the actuator assembly is connected to the cover panel. The output element moves according to movement of the cover panel between the closed position and the opened position. A clutch is coupled between the electrically operable motor and the output element. The clutch, when a torque load at the output element is below a threshold torque load, is in an engaged state to connect movement of the output element and the electrically operable motor. When the torque load at the output element is greater than or equal to the threshold torque load, the clutch is in a disengaged state to disconnect movement of the output element and the electrically operable motor. The clutch includes a magnetic biasing element that biases the clutch toward the engaged state. For example, the clutch includes an upstream gear and a downstream gear and the magnetic biasing element provides a compression force to bias respective ends of the gears toward one another. Optionally, the magnetic biasing element provides a torsional biasing force to bias the respective gears toward rotational alignment with one another.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vehicular electric charging system;

FIG. 2 is a perspective view of an actuator having a clutch element that is configured to decouple an output element from an electrically operable motor of the actuator when the output element experiences a high torque load;

FIGS. 3-5 are exploded views of the actuator of FIG. 2;

FIGS. 6-9 are views of the clutch element of the actuator of FIG. 2;

FIGS. 10-16 are views of the detent gear elements and magnetic biasing elements of the clutch element of the actuator of FIG. 2;

FIGS. 17-21 are views of the gear elements and magnetic biasing elements of a clutch element of another actuator;

FIG. 22 is a perspective view of another actuator having a clutch element;

FIGS. 23-25 are exploded views of the actuator of FIG. 22;

FIGS. 26-29 are views of the clutch element of the actuator of FIG. 22;

FIGS. 30-34 are views of the gear elements and magnetic biasing elements of the clutch element of the actuator of FIG. 22; and

FIG. 35 is a diagram comparing the separation force of the clutch element having different strength magnetic biasing elements and a traditional clutch element having a spring biasing element.

### DESCRIPTION OF THE PREFERRED EMBODIMENTS

A vehicular electric charging charge port opening system operates to open and/or close a power charge flap or panel of an electrically powered vehicle that covers a charging connector configured to electrically connect with an electrical connector of a charging wand to charge batteries of the electrically powered vehicle. Aspects of the power charge flap described herein may also be suitable for use with a fuel port cover for covering a fuel filler port or opening of a vehicle that is configured to receive a nozzle that delivers fuel (e.g., gasoline) to a fuel tank of the vehicle via the fuel port.

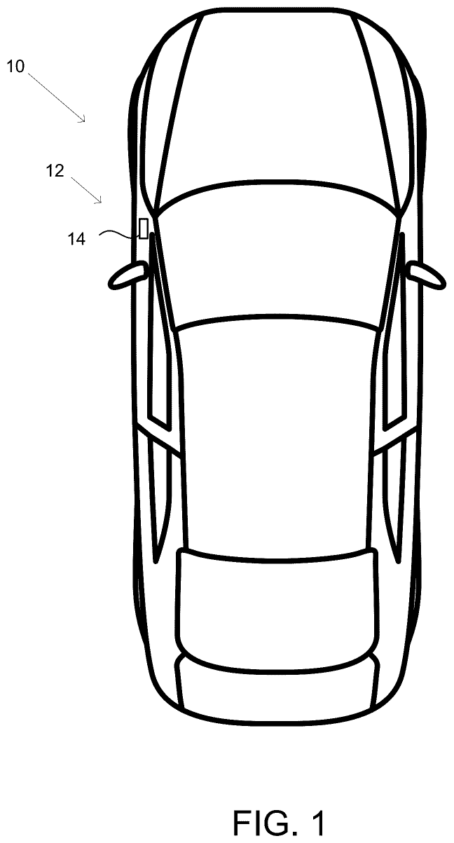

Referring now to the drawings and the illustrative embodiments depicted therein, a vehicle 10 is equipped with one or more vehicular components that are adjustable or pivotable or extendable or deployable relative to the vehicle 10 via a respective actuator assembly or adjustment mechanism coupled to the vehicle and the component (FIG. 1). For example, the vehicle 10 (e.g., an electric vehicle or EV, or a plug-in hybrid vehicle or PHEV) includes an electrical charging system or charge port 12 that includes a base portion or bracket and a cover panel or flap 14. The panel 14 is pivotably mounted at the vehicle or the base portion and has an outer surface that, when the panel 14 is in a closed position, corresponds with and/or is substantially flush with an outer surface of the exterior panel(s) of the vehicle 10 at and around the charge port 12 of the vehicle. When in the closed position, the cover panel 14 conceals a charging connector (not shown) of the charge port 12 that is configured or operable to electrically connect with an electrical connector or charging wand (not shown) of a charging station or system to charge batteries of the vehicle 10. When in an open position, the cover panel 14 moves relative to the base portion and away from the side of the vehicle to reveal the charging connector such that the electrical connector of the charging wand (that is electrically connected to the charging station or system and that is configured or operable for electrically connecting to or plugging into the charging connector of the vehicle) can electrically connect to the charging connector.

As shown in FIG. 1, the charge port 12 is disposed along a side of the vehicle 10 (such as a front driver side portion of the vehicle, or other portion of the vehicle) and, when the cover panel 14 is in the closed position, the exterior surface of the panel 14 is substantially flush with and corresponds to the exterior surface of the vehicle 10 and/or the base portion at or surrounding the charge port 12. The charge port 12 may be disposed at any suitable position at the exterior of the vehicle. For example, the charge port 12 may be disposed at the front or rear fender or bumper of the vehicle. Optionally, the charge port 12 may be concealed behind an exterior feature of the vehicle 10, such as a manufacturers emblem, a portion of a headlight or taillight, a license plate bracket, or the like, where the closure system enables movement of the exterior feature between the closed and opened positions.

When the cover panel 14 is in the closed position, the cover panel 14 may at least partially compress a sealing element or gasket between a rear or interior side or an edge region of the cover panel 14 and the base portion or side of the vehicle surrounding the charge port 12 to protect the connector portion and limit or preclude moisture and contaminants from entering the charge port 12 when the cover panel 14 is closed. For example, the sealing element may be disposed at the interior side of the cover panel 14 or at the base portion and configured to at least partially circumscribe the connector when the cover panel 14 is closed.

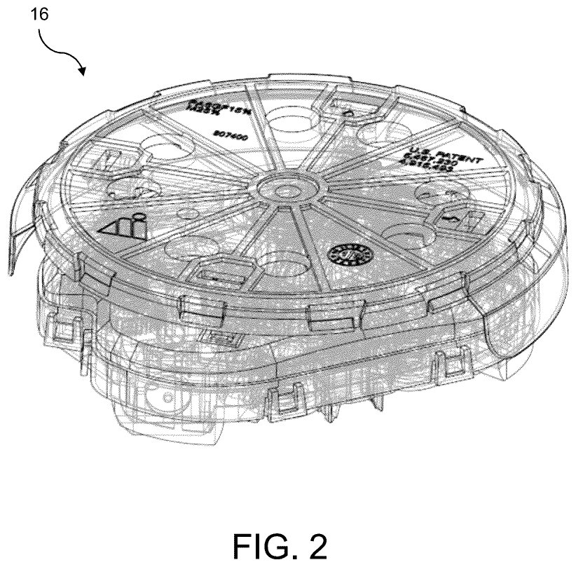

The cover panel 14 is movable between the closed position and the opened position via operation of an electrically operable actuator 16 (FIG. 2), which may be electrically operated to move the cover panel in response to a user input. For example, the actuator 16 may deploy the cover panel 14 in response to a user input at a key fob associated with the vehicle, a button or sensor at the exterior surface of the charge port 12 or vehicle, or a button at the interior of the vehicle cabin, or the actuator may provide a passive opening system, where the actuator operates responsive to a sensor (e.g., a proximity sensor) that senses the user or fob when the user or fob (or other communication device or sensed element) approaches the charge port and/or is within a threshold distance to the charge port. When actuated, the actuator 16 (such as an electrically operable motor of the actuator) operates to move the cover panel 14 from the closed position toward the opened position, and the cover panel 14 may move relative to the base portion or vehicle in any suitable manner, such as in a swinging or pivoting motion outward from the vehicle (such as upward or sideward from the vehicle), or in a sliding motion along the surface of the vehicle (such as along an interior surface of the body panel or an outer surface of the body panel), or in a rotating motion about a pivot axis substantially perpendicular to the surface of the vehicle (such as along the interior surface or outer surface of the body panel), and the like. For example, the cover panel and actuator may utilize characteristics of the charge ports and charging systems described in U.S. Publication Nos. US-2024-0109409 and/or US-2023-0191926, and/or U.S. patent application Ser. No. 18/419,751, filed Jan. 23, 2024 (Attorney Docket DON09 P5045), Ser. No. 18/443,744, filed Feb. 16, 2024 (Attorney Docket DON10 P5080) and/or Ser. No. 18/619,751, filed Mar. 28, 2024 (Attorney Docket DON10 P5089), which are hereby incorporated herein by reference in their entireties. Although discussed herein with respect to the charge port and the cover panel of the vehicle, it should be understood that aspects of the actuator assembly 16 may be utilized with any suitable vehicular component, such as an exterior rearview mirror assembly or powerfold exterior rearview mirror assembly, a door handle assembly for opening a side door and/or liftgate of the vehicle, a pivotable headlamp or corresponding cover, a camera wing, and the like.

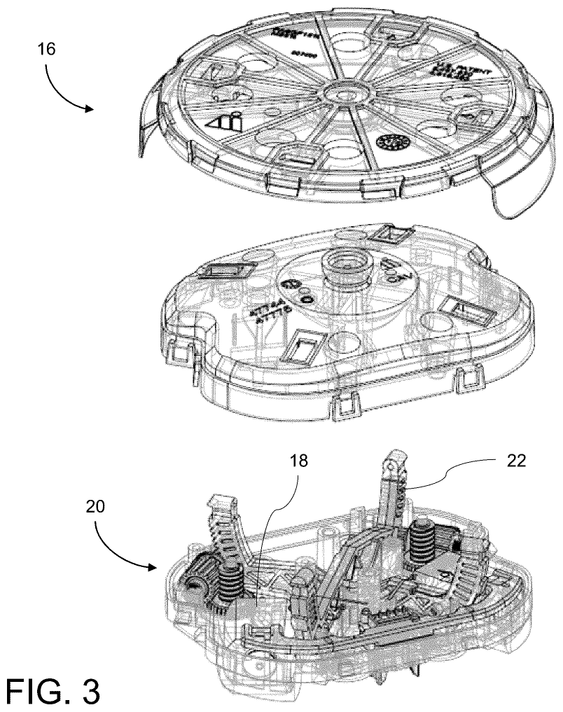

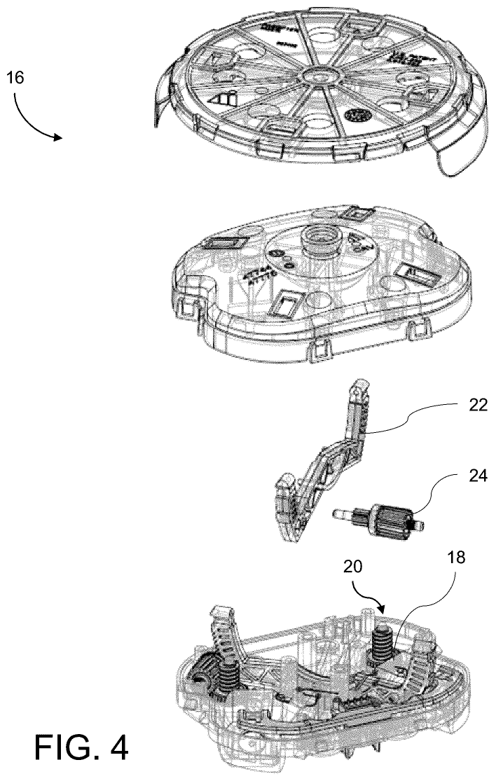

Referring to FIGS. 2-5, the actuator 16 includes an electrically operable motor 18 that, when the actuator 16 is electrically operated to move the vehicular component (e.g., to move the cover panel between the closed position and the opened position), drives a gear train 20 that is coupled to and drives an output element 22 of the actuator. The output element 22 is coupled to and moves with the vehicular component. That is, when the output element 22 is driven by operation of the motor 18, the output element 22 imparts movement of the vehicular component. When the vehicular component is manually moved (e.g., when the cover panel is manually moved by a user between the closed position and the opened position), the output element 22 moves with the vehicular component.

The actuator 16 and output element 22 may move in any suitable manner to impart movement of the vehicular component. For example, the actuator may rotatably drive a helical element that engages a portion of the vehicular component (e.g., an inner surface or pivot arm of the cover panel) to move the vehicular component when the helical element is rotated. That is, the helical element may include a lobe that rotates about an axis and engages a portion of the vehicular component. As the helical element rotates, the portion of the vehicular component rides along a surface of the lobe to move the vehicular component relative to the side of the vehicle. Optionally, the actuator drives a linear output element that, when driven by the actuator, moves axially relative to the actuator and vehicular component to move the vehicular component between positions. In other words, the linear output element engages a portion of the vehicular component and extends and retracts relative to the actuator to move the vehicular component relative to the side of the vehicle. Optionally, the actuator may utilize aspects of the actuators described in U.S. Publication Nos. US-2024-0109409; US-2024-0035318; US-2023-0027125 and/or US-2022-0341226, and/or U.S. patent application Ser. No. 18/414,533, filed Jan. 17, 2024 (Attorney Docket DON08 P5038), and/or Ser. No. 18/416,029, filed Jan. 18, 2024 (Attorney Docket DON08 P5040), which are hereby incorporated herein by reference in their entireties.

To protect the motor 18 from high torque loads (e.g., ice buildup or presence of an obstacle at the exterior surface of the cover panel that resists movement of the cover panel from the closed position toward the opened position) and/or enable manual movement of the vehicular component, the actuator 16 includes a clutch element 24 coupled between the motor 18 and the output element 22. For example, the clutch element 24 may be disposed as part of the gear train 20 and between one of the gears of the gear train 20 and the output element 22. Thus, when the resistance or torque load at the vehicular component exceeds a threshold torque load, such as when the vehicular component is manually moved or the motor 18 is operated with resistance at the exterior surface of the cover panel, the clutch 24 slips or separates to decouple the output element 22 from the one gear of the gear train 20 and motor 18. Thus, the output element 22 is allowed to move with the vehicular component without imparting movement to the motor 18 and/or the motor 18 may be operated without being overloaded. Optionally, the actuator includes a plurality of motors that drive respective ones of a plurality of output elements and one or more clutch elements may couple the motors to the respective output elements to decouple the respective motors from the respective output elements when the torque limit is exceeded and/or the vehicular component is manually moved.

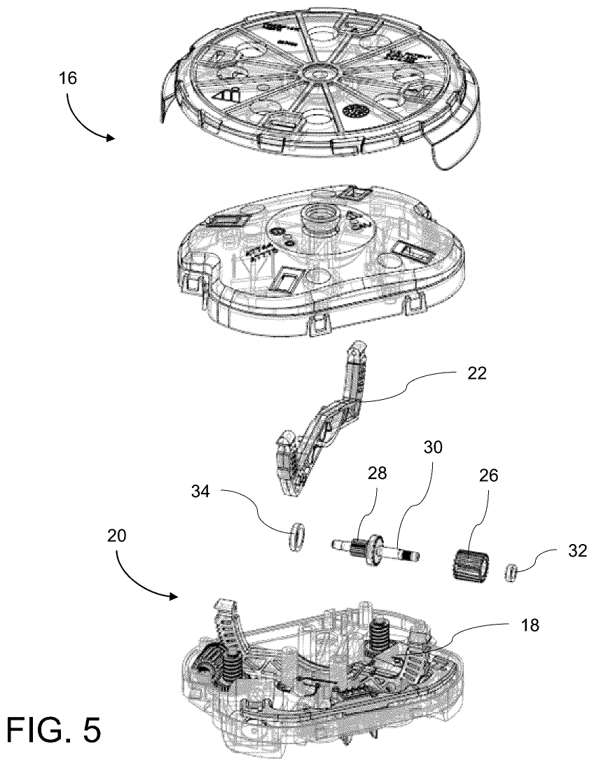

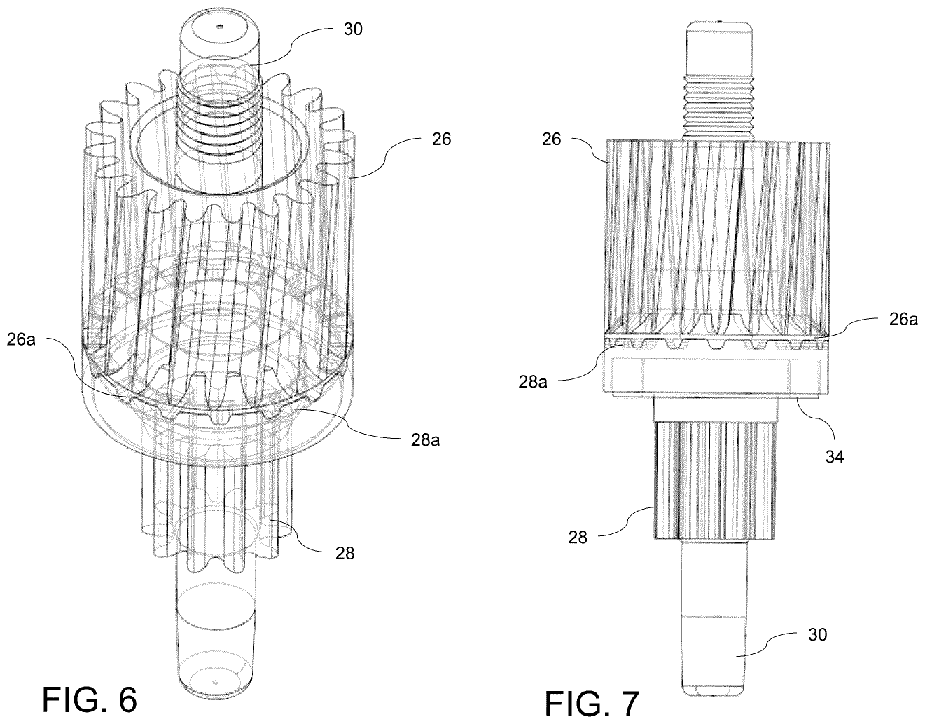

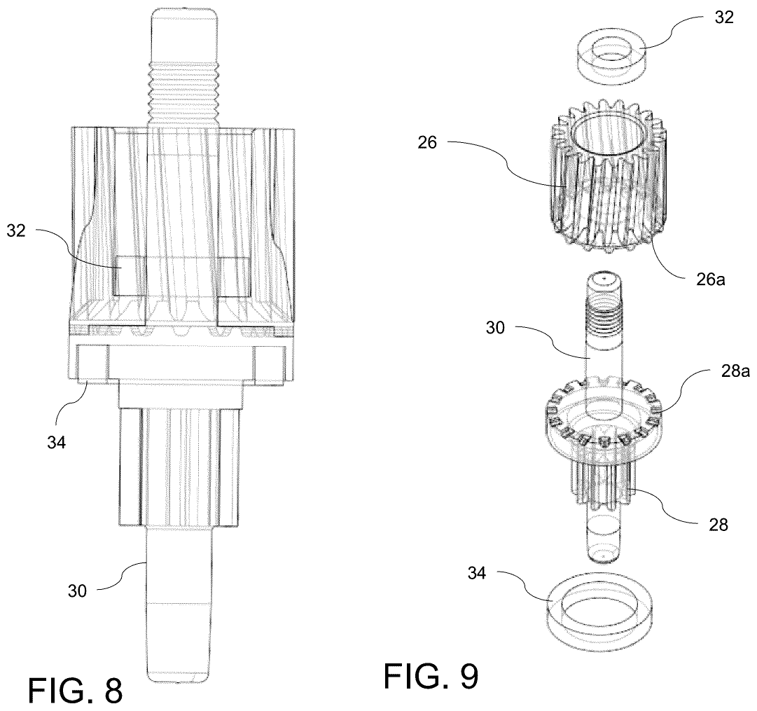

As shown in FIGS. 5-9, the clutch element 24 includes a first or upstream gear element 26 that engages the one gear of the gear train and is rotatably driven by the gear train 20 and the motor 18. The upstream gear 26 is coupled to and drives a second or downstream gear element 28 that is coupled to and drives the output element 22. Thus, and as described further below, the downstream gear element 28 rotates according to movement of the output element 22 and, when the torque load exceeds the threshold torque load, the downstream gear element 28 and the upstream gear element 26 slip relative to one another or decouple from one another to decouple the motor 18 and the gear train 20 from the output element 22. A clutch shaft 30 extends along the downstream gear element 28 and the upstream gear element 26 so that the upstream gear element 26 may pivot about the clutch shaft 30 when the downstream gear element 28 is restrained (e.g., from a torque load at the vehicular component) during operation of the motor 18 and the upstream gear element 26 rotates relative to the downstream gear element 28 according to movement of the output element 22. For example, the clutch shaft 30 may be integrally formed with and extend from the downstream gear element 28.

A detent interface is disposed between the upstream gear element 26 and the downstream gear element 28 so that when the detent interface is engaged, the upstream gear element 26 drives the downstream gear element 28 and thus the clutch 24 drives the output element 22. When the torque load at the vehicular component exceeds the threshold torque amount, the detent interface disengages or slips to decouple the upstream gear element 26 from the downstream gear element 28. In the illustrated example, the detent interface includes a series of ramps and protrusions or teeth forming a first detent surface 26a along an end surface of the upstream gear element 26 that engage corresponding ramps and protrusions or teeth of a second detent surface 28a along an end surface of the downstream gear element 28. When the torque load exceeds the threshold torque load, the respective ramps and protrusions ride along one another to axially move the upstream gear element 26 along the clutch shaft 30 away from the downstream gear element 28.

The upstream gear element 26 and the downstream gear element 28 are magnetically biased toward one another to bias the detent interface into engagement. That is, an attractive magnetic force urges the upstream gear element and the downstream gear element 28 toward one another along the clutch shaft 30 to urge the detent interface into engagement. For example, a first or upstream magnet 32 is disposed along the clutch shaft 30 and between the first detent interface 26a and an upstream end of the clutch shaft 30, and a second or downstream magnet 34 is disposed along the clutch shaft 30 and between the second detent interface 28a and a downstream end of the clutch shaft 30. The upstream magnet 32 may be attached to the upstream gear element 26 and the downstream magnet 34 may be attached to the downstream gear element 28 such that the respective magnets and gear elements move together and in tandem along the clutch shaft 30 as the upstream gear element 26 moves relative to the downstream gear element 28. Optionally, the upstream magnet 32 and the downstream magnet 34 may be integrally formed with or accommodated within the respective gear elements and/or the respective gear elements may be formed from magnetic material, such that the upstream gear element 26 and the downstream gear element 28 are magnetically attracted toward one another.

Thus, the clutch element 24 is magnetically biased toward engagement where operation of the motor to drive the gear train 20 imparts movement of the clutch element 24 and the output element 22 and, based on the torque load at the output element 22 overcoming at least the magnetic biasing force at the clutch element 24, the clutch element 24 disengages to disconnect movement of the output element 22 from the gear train 20. That is, when the clutch element 24 is engaged, the actuator is operable to move the cover panel between the opened and closed positions and the output element moves according to movement of the gear train and clutch element. When the torque load at the output element is greater than the threshold level of torque (e.g. the cover panel is manually moved between the opened and closed positions or resistance at the cover panel prevents the cover panel from moving), the clutch element 24 disengages and the output element and gear train move relative to each other.

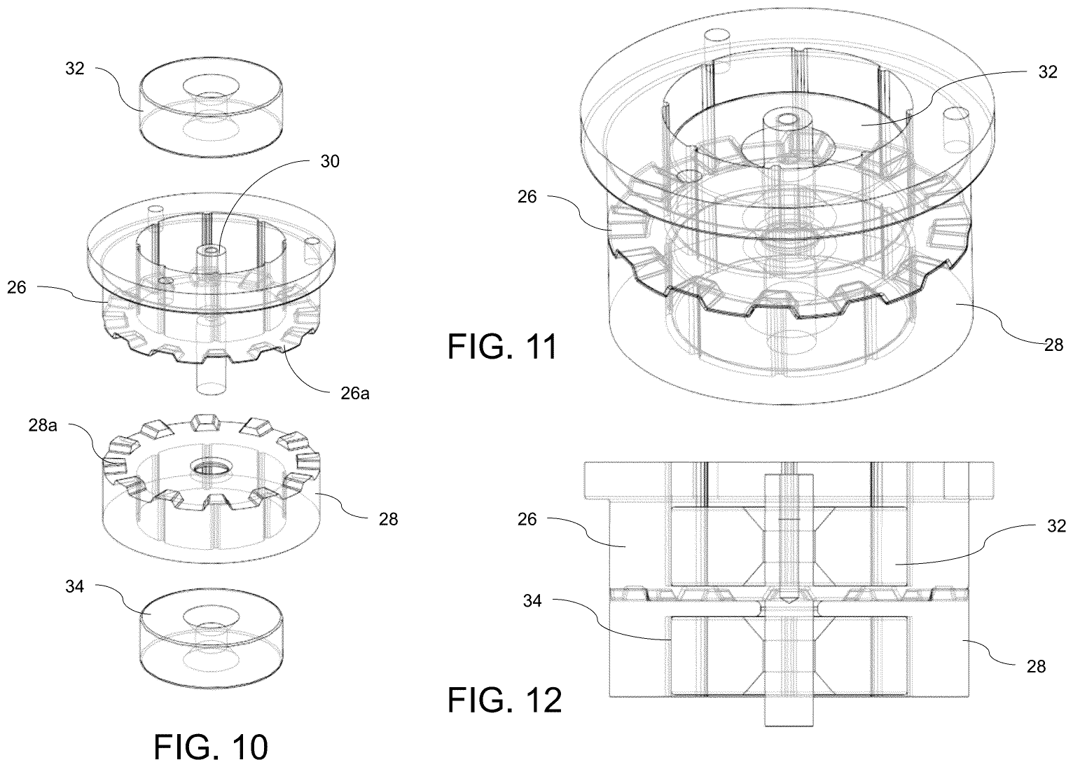

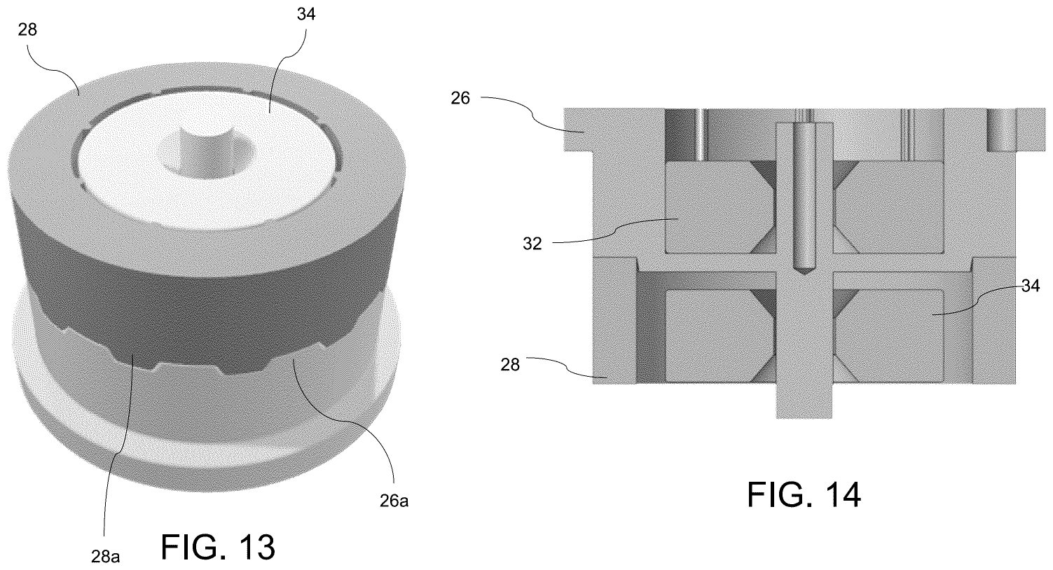

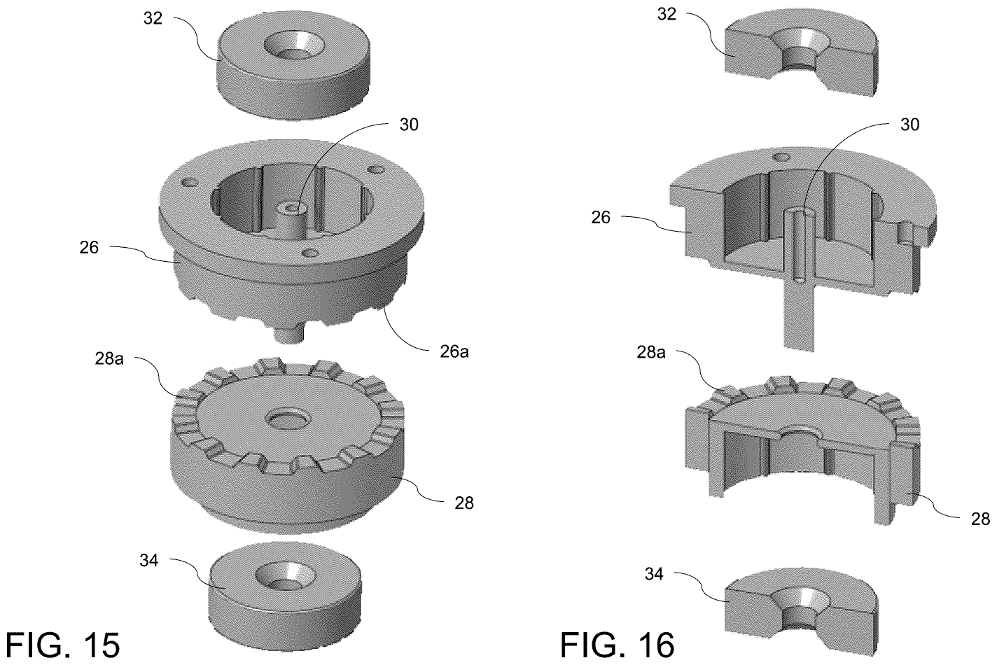

As shown in FIGS. 9-16, the upstream magnet 32 is disposed radially inboard of the upstream gear element 26 and at least partially along a central recess of the upstream gear element 26. The downstream magnet 34 is disposed radially outboard of the downstream gear element 28 and engages an annular surface that is opposite the second detent interface 28a at an end of the downstream gear element 28. Optionally, the downstream magnet 34 is disposed at least partially along a central recess of the downstream gear element 28.

Thus, the upstream magnet 32 and the downstream magnet 34 are attracted toward one another and provide a magnetic force biasing the upstream gear element 26 and first detent interface 26a toward engagement with the downstream gear element 28 and the second detent interface 28a. Thus, the threshold torque load is defined at least partially by the magnetic force between the upstream magnet 32 and the downstream magnet 34 and the frictional force between the first detent interface 26a and the second detent interface 28a. When the torque load at the vehicular component exceeds the threshold torque load, the upstream gear 26 and the downstream gear 28 separate from one another to decouple the vehicular component and output element 22 from the motor 18.

In other words, the clutch element 24 uses magnets to create a compression force between the two different sections of the clutch. Further, detents in the housings of the clutch create additional rotational resistance. For example, the magnets may provide 80 Newtons of pull strength resistance (e.g., at least 80 Newtons of pull strength are required to separate the upstream and downstream clutch elements) with the detented clutch surface. The magnets may provide a strong retaining force, such that wearing or deterioration of the clutch surface does not have a significant impact on slip torque during the life of the clutch element.

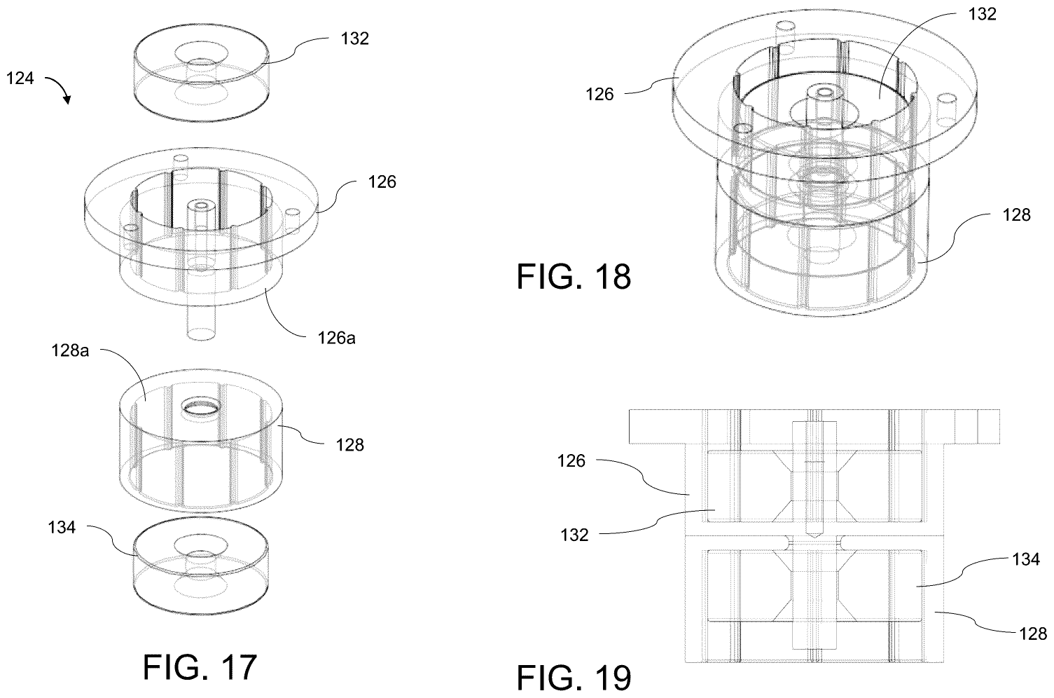

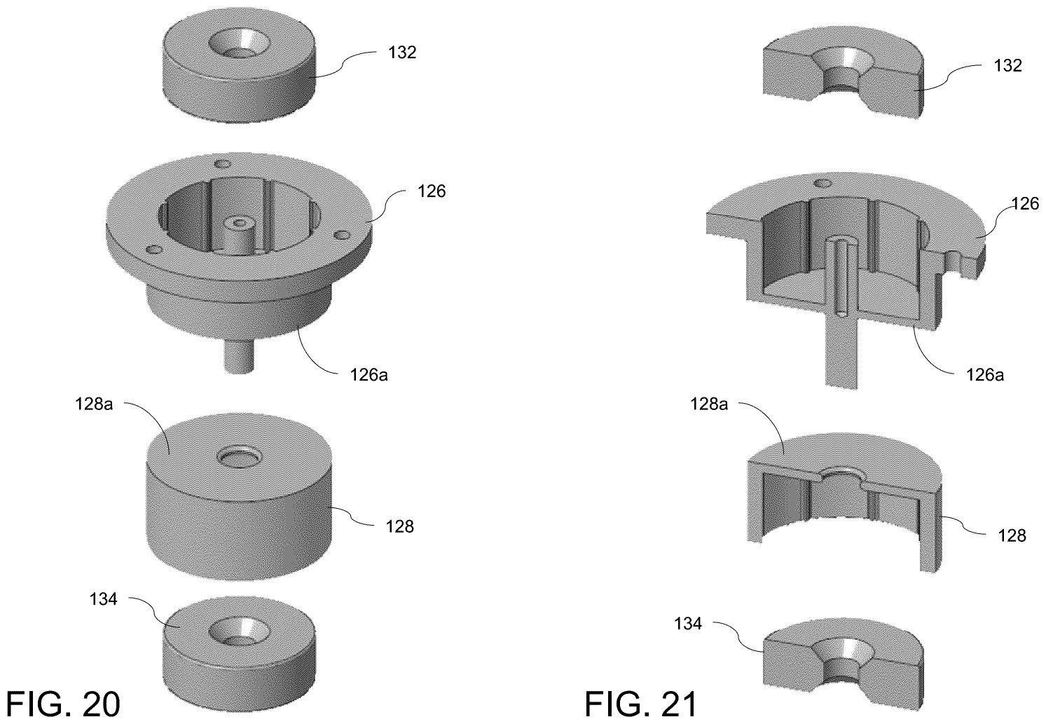

Optionally, and such as shown in FIGS. 17-21, a clutch element 124 includes an upstream gear element 126 and a downstream gear element 128 that are magnetically biased toward engagement with one another via an upstream magnet 132 and a downstream magnet 134, where the interface between the respective gear elements does not include a detent interface. In other words, the annular engagement surface 126a of the upstream gear element 126 and the annular engagement surface 128a of the downstream gear element 128 do not include ramps or protrusions and may comprise substantially smooth annular surfaces configured to engage one another. Thus, the threshold torque load is substantially defined by the compressive force between the upstream magnet 132 and the downstream magnet 134 and the frictional force between the substantially smooth annular engagement surfaces. When the torque load at the vehicular component is greater than the threshold torque load, the upstream gear element 126 slips relative to the downstream gear element 128. Optionally, the engagement surface 126a of the upstream gear element 126 and/or the engagement surface 128a of the downstream gear element may include a frictional surface, such that the surface includes a rough or coarse surface finish and there is a high coefficient of friction between the engagement surfaces.

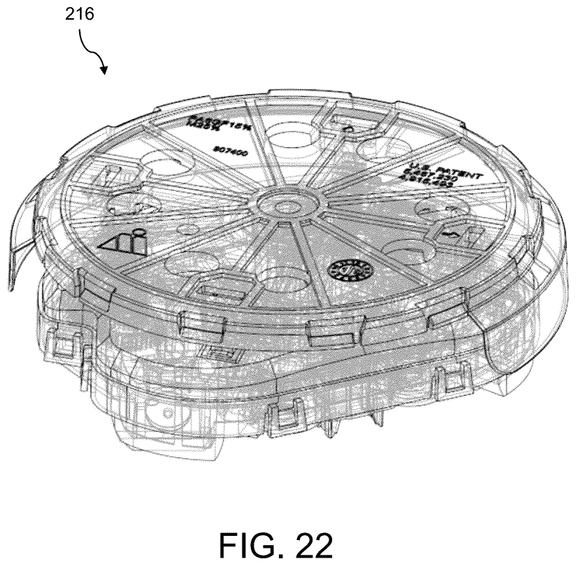

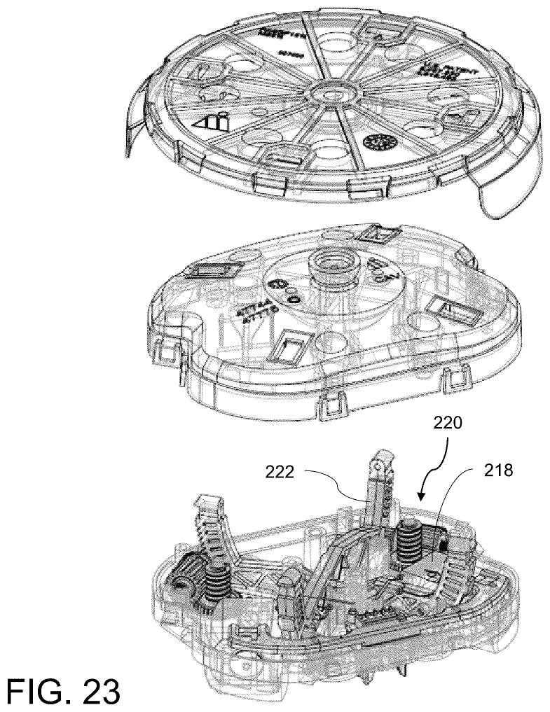

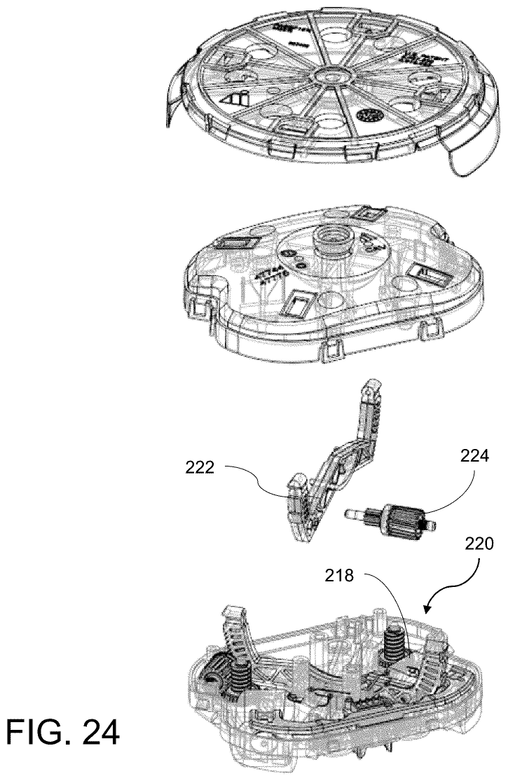

Referring to FIGS. 22-25, an actuator 216 includes a clutch element 224 disposed between the motor 218 and the output element 222 so that the clutch element 224 may decouple the motor 218 and/or gear train 220 from the output element 222 when a torque load at the output element 222 is greater than the threshold torque load (such as due to ice buildup at the cover panel or manual movement of the cover panel), as enabled by the clutch element 224.

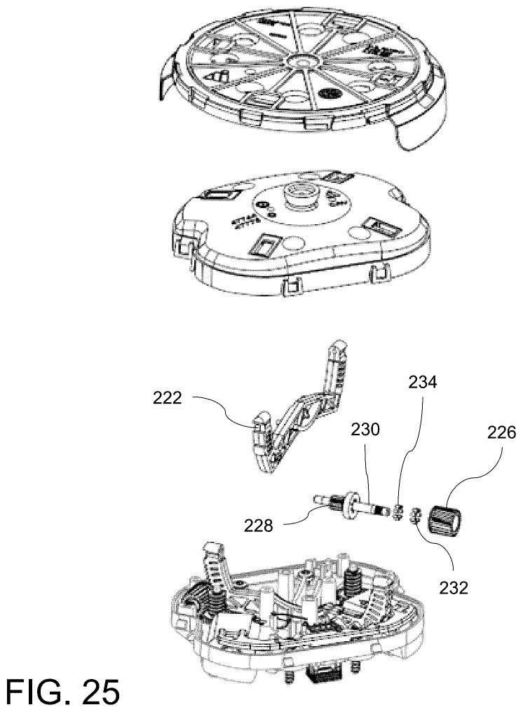

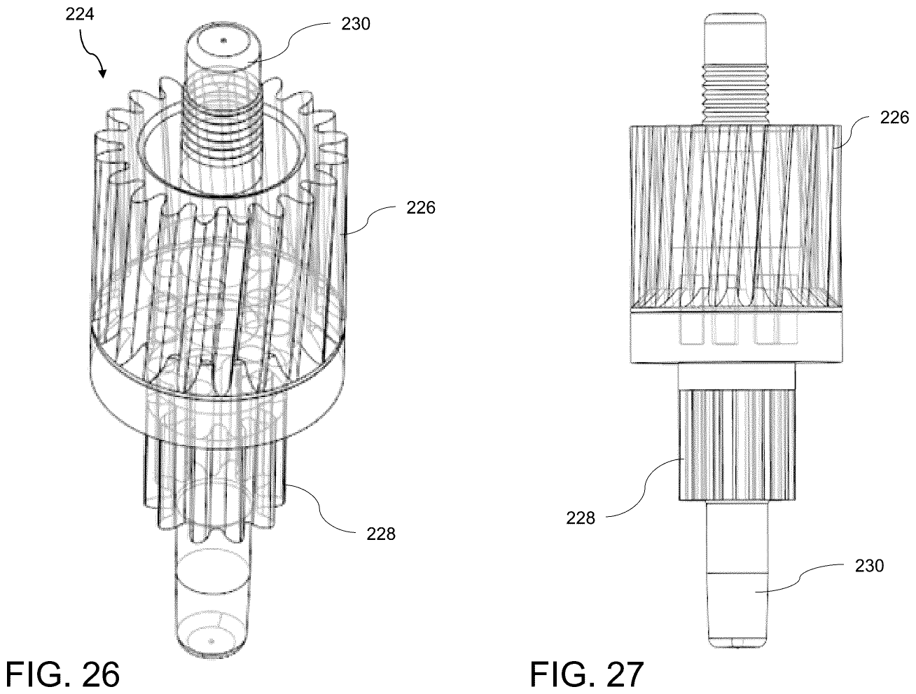

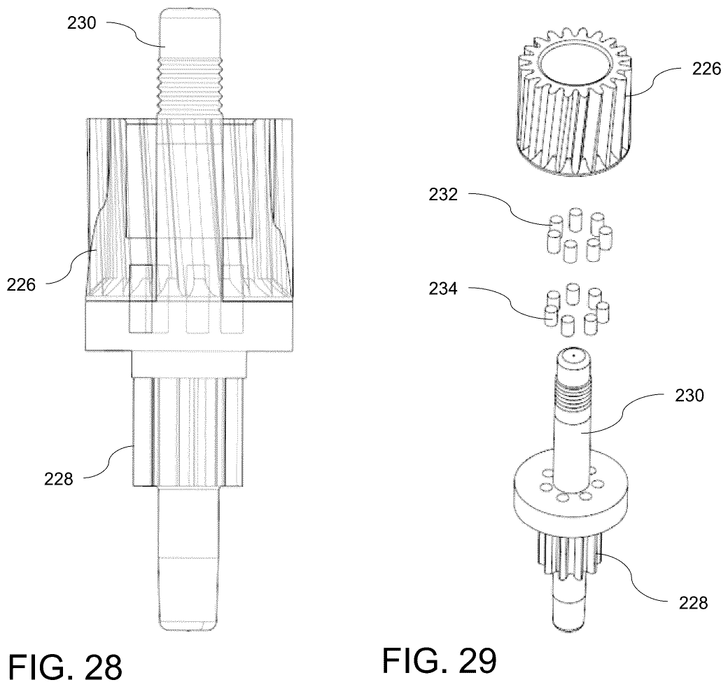

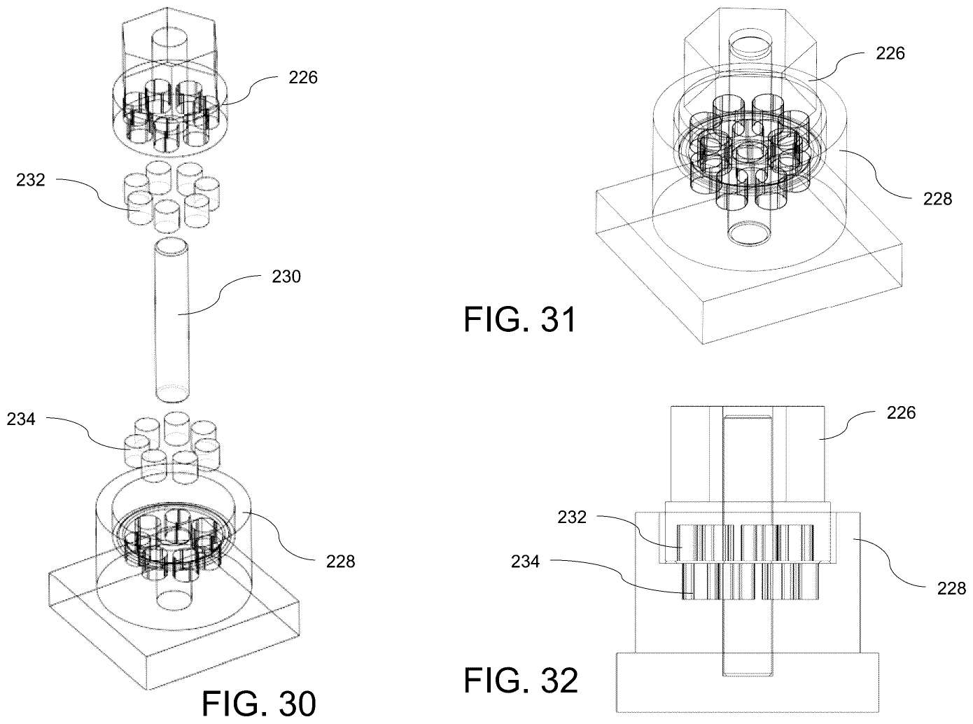

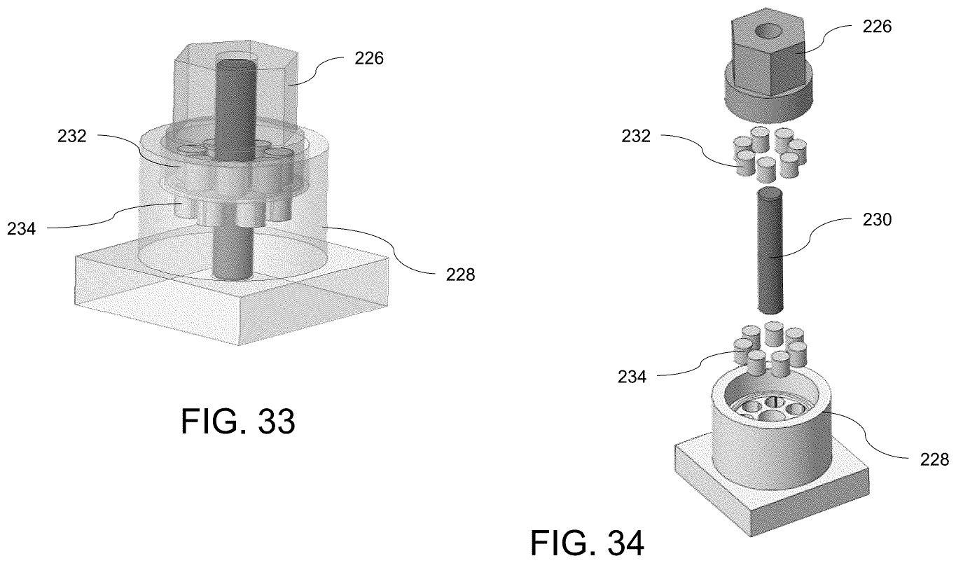

As shown in FIGS. 25-34, the clutch element 224 includes a first or upstream gear element 226 that engages and is rotatably driven by the gear train 220 and the motor 218. The upstream gear 226 is coupled to and drives a second or downstream gear element 228 that is coupled to and drives the output element 222. A clutch shaft 230 extends from the downstream gear element 228 and along the upstream gear element 226 so that the upstream gear element 226 may pivot about the clutch shaft 230 when the downstream gear element 228 is restrained (e.g., from a torque load at the vehicular component) during operation of the motor 218 and the upstream gear element 226 rotates relative to the downstream gear element 228.

Magnetic elements disposed at the upstream gear element 226 and the downstream gear element 228 provide a torsional magnetic biasing force to rotationally couple the upstream gear element 226 and the downstream gear element 228. That is, a first set or upstream plurality of magnets 232 are disposed at the upstream gear element 226 and are rotationally fixed relative to the upstream gear element 226. A second set or downstream plurality of magnets 234 are disposed at the downstream gear element 228 and are rotationally fixed relative to the downstream gear element 228. For example, the respective magnets are each received in a corresponding aperture or receiving portion of the upstream gear element 226 or downstream gear element 228. The upstream magnets 232 are magnetically attracted to the respective downstream magnets 234.

The respective sets of magnets are arranged at the upstream gear element 226 and the downstream gear element 228 so as to at least partially circumscribe the clutch shaft 230 and the axis of rotation of the clutch element 224. Further, the respective sets of magnets are arranged at the respective gear elements to form a non-continuous ring of magnets about the axis of rotation. Thus, the magnetic attraction between the respective upstream magnets 232 and the respective downstream magnets 234 rotationally biases the upstream gear element 226 and the downstream gear element 228 to maintain alignment between the respective sets of magnets. In other words, if the upstream gear element 226 and the downstream gear element 228 begin to slip relative to one another due to a torque load at the vehicular component, the magnetic attraction between individual ones of the upstream magnets 232 and the downstream magnets 234 urges the upstream gear element 226 and/or downstream gear element 228 about the axis of rotation toward a position where the magnets are aligned. This provides a torsional biasing force between the upstream gear element 226 and the downstream gear element 228 to rotationally fix the respective gear elements when the torque load is below the threshold torque load.

Thus, the threshold torque load is substantially defined by the magnetic force between the upstream magnets 232 and the downstream magnets 234 and optionally a frictional force between an annular engagement surface 226a of the upstream gear element 226 engaging an annular engagement surface 228a of the downstream gear element 228. Optionally, one of the upstream gear element 226 and the downstream gear element 228 is at least partially received within a recess of the other gear element. For example, the upstream gear element 226 may be received within the downstream gear element 228 and thus rotate within the downstream gear element 228 when the respective gear elements slip relative to one another. Optionally, a detent interface is disposed between the upstream gear element and the downstream gear element. Thus, the clutch element 224 provides a magnetic torsion resistance that uses magnet polarity to create the torsional resistance.

The magnetic clutch element may use any suitable magnetic elements, such as neodymium magnets with measured pull strengths (i.e., force required to separate two magnets) of 27 Newtons, 69 Newtons, 80 Newtons and the like, and respective masses of 1.9 grams, 3.9 grams, 8.7 grams, 12.4 grams and the like. Further, the magnetic clutch element may provide similar or greater slip torque as compared to traditional clutch elements that use compression springs while having the same or fewer parts. For example, a magnetic clutch element may separate or disengage under a load of about 48 Newton centimeters of torque and have four parts or components, while a traditional compression spring clutch may have three or four or six or more parts or components. The clutch elements with magnetic biasing members provide improved performance over the life of the actuator as wear on the detent and/or engagement interface between the upstream portion of the clutch element and the downstream element of the clutch element has a limited effect on the threshold torque level of the clutch element. In other words, even after wear occurs between the upstream and downstream portions of the clutch element, the biasing force between the upstream and downstream portions remains substantially the same due to the magnetic biasing members.

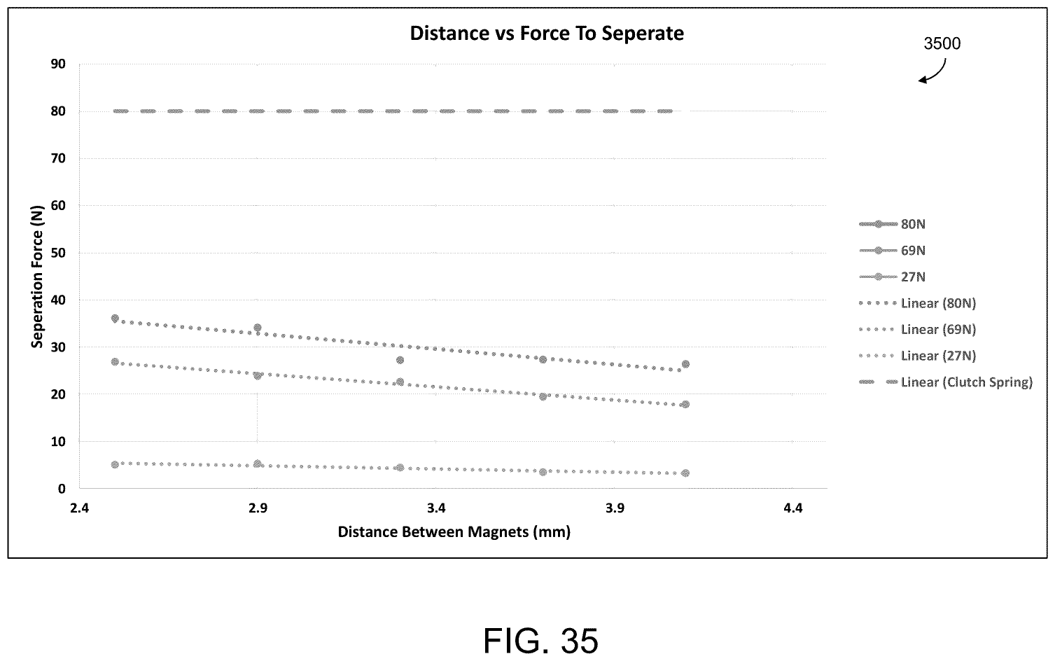

Further, and as shown in the diagram 3500 of FIG. 35, the separation force of the magnetic clutch element 124 (i.e., the force required to separate two magnets or the force required to separate the upstream gear element and the downstream gear element) having different strength magnetic elements is compared to the separation force of a traditional clutch element having a compression spring biasing element. As shown, the separation force of the magnetic clutch element 124 decreases as the distance between the magnetic elements increases, while the separation force of the traditional clutch element remains the same.

Optionally, the magnetic elements of the clutch element may comprise electromagnets that may be electrically charged to adjust and/or operate the clutch element. For example, the electromagnets may be electrically charged to increase the magnetic field at the clutch element and thus increase the biasing force between the upstream portion of the clutch and the downstream portion of the clutch. This would increase the threshold torque load and cause the actuator to electrically operate to move the vehicular component under higher torque loads.

Further, the electromagnets may not be electrically charged to reduce or eliminate the magnetic field at the clutch element and therefore decrease the biasing force between the upstream portion of the clutch and the downstream portion of the clutch. This would decrease and/or eliminate the threshold torque load and cause the actuator to slip under lower or zero torque load. For example, electromagnets may not be electrically charged to enable easy manual operation of the vehicular component while the electromagnets may be electrically charged to provide a locking function of the vehicular component.

The charge ports described herein may be illuminated via any suitable means, and may utilize aspects of the charge ports and systems described in U.S. Pat. No. 8,317,376 and/or U.S. Publication No. US-2023-0191926, which are hereby incorporated herein by reference in their entireties. The vehicle may include various indicators to indicate the charge level of the vehicle, such as by utilizing aspects of the systems described in U.S. Pat. No. 10,746,575 and/or U.S. Publication No. US 2021/0129757, which are hereby incorporated herein by reference in their entireties.

Optionally, the system and cover may operate to provide autonomous charging and may open the cover panel and pivot or move the charging connector responsive to determination of presence of the charging wand, and may control movement of the charging wand to guide the wand into electrical connection with the charging connector when the panel is opened and the connector is pivoted or moved to its charging position. The system may provide a passive way of charging electric vehicles (or plug-in hybrid vehicles or PHEVs) assisted by ultra-wideband (UWB) time of flight distance measurements (which may be made via processing of data captured by one or more time of flight sensors and/or transmitters disposed at the vehicle charge port and/or sensing or communicating with the charging wand), such as by utilizing aspects of the systems described in U.S. Publication No. US-2023-0133911, which is hereby incorporated herein by reference in its entirety. A communication gateway in communication with a PCF may automatically establish a connection with the charging station the electric vehicle is parked at. This automates the process of charging the vehicles (i.e., reduces or eliminates human intervention). The system allows for the charging station plug of the charging station to be guided to the charging socket of the electric vehicle using range and vector communication supplied by a UWB antenna system.

Optionally, the actuator assembly may be suitable for use with a powerfold exterior rearview mirror assembly, where the output element is driven by the actuator to move the mirror assembly between an extended or use position and a folded or non-use position relative to the side of the vehicle. The powerfold mirror actuator may utilize aspects of the actuators described in U.S. Pat. Nos. 7,887,202; 9,487,142; 11,396,264 and/or 9,067,541, and/or U.S. Publication Nos. US-2020-0223364; US-2021-0261053 and/or US-2022-0126751, and/or International Publication No. WO 2019/035078, which are all hereby incorporated herein by reference in their entireties. The mirror assembly may utilize aspects of the mirror assemblies described in U.S. Publication Nos. US-2021-0331625; US-2021-0316664; US-2021-0213880; US-2020-0353867 and/or US-2020-0223364, and/or U.S. Pat. Nos. 11,325,535; 10,099,618; 9,827,913; 9,487,142; 9,346,403 and/or 8,915,601, which are all hereby incorporated herein by reference in their entireties.

Optionally, the actuator assembly may be suitable for use with an extendable and retractable door handle assembly, where the output element is driven by the actuator to move the handle assembly between an extended or graspable position and a retracted or non-graspable position relative to the door or liftgate or closure panel of the vehicle. The handle assembly may comprise any suitable type of handle assembly, and the handle assembly and actuator may include or incorporate aspects of the door handle assemblies and actuators described in U.S. Pat. Nos. 8,786,401; 6,977,619; 7,407,203; 6,349,450; 6,550,103; 6,907,643; 8,801,245 and/or 8,333,492, and/or U.S. Publication Nos. US-2024-0035318; US-2022-0018168; US-2022-0282534; US-2022-0341226; US-2010-0088855; US-2010-0007463 and/or US-2020/0102773, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular charge port closure system, the vehicular charge port closure system comprising:
a cover panel disposed at a charge port of a vehicle equipped with the vehicular charge port closure system, wherein the cover panel is movable between (i) a closed position where the cover panel conceals the charge port of the vehicle and (ii) an opened position where the cover panel is positioned to allow access to a charging connector of the charge port;
an actuator that is electrically operable to move the cover panel between the closed position and the opened position;
wherein the actuator comprises an electrically operable motor that, when the actuator is electrically operated to move the cover panel between the closed position and the opened position, drives gears to impart movement of an output element of the actuator;
wherein the output element of the actuator is connected to the cover panel;
wherein a clutch is disposed between one of the gears and the output element, and wherein, when the electrically operable motor of the actuator is electrically operated to drive the gears, the clutch is engaged to move the cover panel between the closed position and the opened position;
wherein the cover panel is manually movable between the closed position and the opened position, and wherein, when the cover panel is manually moved between the closed position and the opened position, the clutch is disengaged; and
wherein the clutch comprises a magnetic biasing element.

2. The vehicular charge port closure system of claim 1, wherein the clutch comprises (i) an upstream gear that is rotationally fixed relative to the one of the gears and (ii) a downstream gear that is rotationally fixed relative to the output element, and wherein, when the clutch is engaged, the upstream gear is rotationally fixed relative to the downstream gear, and wherein, when the clutch is disengaged, the upstream gear and the downstream gear are rotationally disconnected.

3. The vehicular charge port closure system of claim 2, wherein both of the upstream gear and the downstream gear rotate about an axis of rotation, and wherein respective end surfaces of the upstream gear and the downstream gear engage one another when the clutch is engaged, and wherein the magnetic biasing element biases the upstream gear and the downstream gear axially toward one another to bias the respective end surfaces of the upstream gear and the downstream gear toward engagement with one another.

4. The vehicular charge port closure system of claim 3, wherein a detent interface is disposed between the respective end surfaces of the upstream gear and the downstream gear.

5. The vehicular charge port closure system of claim 3, wherein a frictional interface is disposed between the respective end surfaces of the upstream gear and the downstream gear.

6. The vehicular charge port closure system of claim 3, wherein the magnetic biasing element comprises an upstream magnet and a downstream magnet, and wherein the upstream gear and the downstream gear are disposed along the axis of rotation between the upstream magnet and the downstream magnet, and wherein the upstream magnet and the downstream magnet are magnetically attracted toward one another along the axis of rotation and bias the upstream gear and the downstream gear axially toward one another.

7. The vehicular charge port closure system of claim 2, wherein both of the upstream gear and the downstream gear rotate about an axis of rotation, and wherein the magnetic biasing element biases the upstream gear and the downstream gear about the axis of rotation toward rotational alignment with one another.

8. The vehicular charge port closure system of claim 7, wherein the magnetic biasing element comprises a plurality of upstream magnets disposed at the upstream gear and a plurality of downstream magnets disposed at the downstream gear, and wherein the plurality of upstream magnets and the plurality of downstream magnets are magnetically attracted toward one another and bias the upstream gear and the downstream gear about the axis of rotation toward rotational alignment with one another.

9. The vehicular charge port closure system of claim 1, wherein the magnetic biasing element comprises one or more neodymium magnets.

10. The vehicular charge port closure system of claim 1, wherein, when the electrically operable motor is electrically operated to drive the gears, and when a torque load at the output element is below a threshold torque load, the clutch is engaged to move the cover panel between the closed position and the opened position, and wherein, when the electrically operable motor is electrically operated to drive the gears, and when the torque load at the output element is above the threshold torque load, the clutch is disengaged.

11. The vehicular charge port closure system of claim 1, wherein a sealing element is disposed at the cover panel, and wherein the cover panel, when in the closed position, compresses the sealing element.

12. The vehicular charge port closure system of claim 1, wherein the magnetic biasing element biases the clutch toward an engaged position where the clutch connects movement of the one of the gears and the output element so that, when the electrically operable motor of the actuator is electrically operated to drive the gears, the clutch imparts movement of the output element to move the cover panel between the closed position and the opened position.

13. The vehicular charge port closure system of claim 12, wherein, when the cover panel is manually moved between the closed position and the opened position, and with the clutch disengaged, the output element moves relative to the one of the gears.

14. A vehicular charge port closure system, the vehicular charge port closure system comprising:
a cover panel disposed at a charge port of a vehicle equipped with the vehicular charge port closure system, wherein the cover panel is movable between (i) a closed position where the cover panel conceals the charge port of the vehicle and (ii) an opened position where the cover panel is positioned to allow access to a charging connector of the charge port;
an actuator that is electrically operable to move the cover panel between the closed position and the opened position;
wherein the actuator comprises an electrically operable motor that, when the actuator is electrically operated to move the cover panel between the closed position and the opened position, drives gears to impart movement of an output element of the actuator;
wherein the output element of the actuator is connected to the cover panel;
wherein a clutch is disposed between one of the gears and the output element, and wherein, when the electrically operable motor of the actuator is electrically operated to drive the gears, the clutch is engaged to move the cover panel between the closed position and the opened position;
wherein the cover panel is manually movable between the closed position and the opened position, and wherein, when the cover panel is manually moved between the closed position and the opened position, the clutch is disengaged;
wherein, when the electrically operable motor is electrically operated to drive the gears, and when a torque load at the output element is above a threshold torque load, the clutch is disengaged;
wherein the clutch comprises (i) an upstream gear that is rotationally fixed relative to the one of the gears, (ii) a downstream gear that is rotationally fixed relative to the output element and (iii) a magnetic biasing element;
wherein, when the clutch is engaged, the upstream gear is rotationally fixed relative to the downstream gear, and wherein, when the clutch is disengaged, the upstream gear and the downstream gear are rotationally disconnected; and
wherein both of the upstream gear and the downstream gear rotate about an axis of rotation, and wherein respective end surfaces of the upstream gear and the downstream gear engage one another when the clutch is engaged, and wherein the magnetic biasing element biases the upstream gear and the downstream gear axially toward one another to bias the respective end surfaces of the upstream gear and the downstream gear toward engagement with one another.

15. The vehicular charge port closure system of claim 14, wherein a detent interface is disposed between the respective end surfaces of the upstream gear and the downstream gear.

16. The vehicular charge port closure system of claim 14, wherein a frictional interface is disposed between the respective end surfaces of the upstream gear and the downstream gear.

17. The vehicular charge port closure system of claim 14, wherein the magnetic biasing element comprises an upstream magnet and a downstream magnet, and wherein the upstream gear and the downstream gear are disposed along the axis of rotation between the upstream magnet and the downstream magnet, and wherein the upstream magnet and the downstream magnet are magnetically attracted toward one another along the axis of rotation and bias the upstream gear and the downstream gear axially toward one another.

18. The vehicular charge port closure system of claim 14, wherein, when the electrically operable motor is electrically operated to drive the gears, and when the torque load at the output element is below the threshold torque load, the clutch is engaged to move the cover panel between the closed position and the opened position.

19. The vehicular charge port closure system of claim 14, wherein the magnetic biasing element biases the clutch toward an engaged position where the clutch connects movement of the one of the gears and the output element so that, when the electrically operable motor of the actuator is electrically operated to drive the gears, the clutch imparts movement of the output element to move the cover panel between the closed position and the opened position.

20. A vehicular charge port closure system, the vehicular charge port closure system comprising:
a cover panel disposed at a charge port of a vehicle equipped with the vehicular charge port closure system, wherein the cover panel is movable between (i) a closed position where the cover panel conceals the charge port of the vehicle and (ii) an opened position where the cover panel is positioned to allow access to a charging connector of the charge port;
an actuator that is electrically operable to move the cover panel between the closed position and the opened position;
wherein the actuator comprises an electrically operable motor that, when the actuator is electrically operated to move the cover panel between the closed position and the opened position, drives gears to impart movement of an output element of the actuator;
wherein the output element of the actuator is connected to the cover panel;
wherein a clutch is disposed between one of the gears and the output element, and wherein, when the electrically operable motor of the actuator is electrically operated to drive the gears, the clutch is engaged to move the cover panel between the closed position and the opened position;
wherein the cover panel is manually movable between the closed position and the opened position, and wherein, when the cover panel is manually moved between the closed position and the opened position, the clutch is disengaged;
wherein, when the electrically operable motor is electrically operated to drive the gears, and when a torque load at the output element is above a threshold torque load, the clutch is disengaged;
wherein the clutch comprises (i) an upstream gear that is rotationally fixed relative to the one of the gears, (ii) a downstream gear that is rotationally fixed relative to the output element and (iii) a magnetic biasing element;
wherein, when the clutch is engaged, the upstream gear is rotationally fixed relative to the downstream gear, and wherein, when the clutch is disengaged, the upstream gear and the downstream gear are rotationally disconnected; and
wherein both of the upstream gear and the downstream gear rotate about an axis of rotation, and wherein the magnetic biasing element biases the upstream gear and the downstream gear about the axis of rotation toward rotational alignment with one another.

21. The vehicular charge port closure system of claim 20, wherein the magnetic biasing element comprises a plurality of upstream magnets disposed at the upstream gear and a plurality of downstream magnets disposed at the downstream gear, and wherein the plurality of upstream magnets and the plurality of downstream magnets are magnetically attracted toward one another and bias the upstream gear and the downstream gear about the axis of rotation toward rotational alignment with one another.

22. The vehicular charge port closure system of claim 20, wherein, when the electrically operable motor is electrically operated to drive the gears, and when the torque load at the output element is below the threshold torque load, the clutch is engaged to move the cover panel between the closed position and the opened position.

23. The vehicular charge port closure system of claim 20, wherein the magnetic biasing element biases the clutch toward an engaged position where the clutch connects movement of the one of the gears and the output element so that, when the electrically operable motor of the actuator is electrically operated to drive the gears, the clutch imparts movement of the output element to move the cover panel between the closed position and the opened position.
